(19) United States
(12) Patent Application Publication
(10) Pub. No.: US 2002/0021887 A1
(43) Pub. Date: Feb. 21, 2002

(54) Image reproduction system and data synchronization method

(76) Inventor: Masato Yoshikawa, Tokyo (JP)

Correspondence Address: McGuireWoods, Suite 1800, 1750 Tysons Boulevard, Tysons Corner, McLean, VA, 22102-4215, US

(21) Appl. No.: 09/919,827

(22) Filed: Aug. 2, 2001

(30) Foreign Application Priority Data
Aug. 9, 2000 (JP) 2000-240549

(51) Int. Cl. H04N 5/91

(52) U.S. Cl. 386/66

(57) ABSTRACT

The present invention is directed to providing an image reproduction system capable of easily establishing synchronization between an image and synchronization data. Reproduction application software 21A of a PC 1 processes and displays image data that have been supplied from data output means 2. Synchronization processing means 21 synchronizes synchronization data with image data, wherein synchronization data are the data relevant to the image data and to be displayed in synchronization with the image data. The times for performing synchronization and the data names of the data to be executed are written in script 25. Synchronization data storage means 22 stores the synchronization data. Image reproduction means 23 displays image data that have been processed by reproduction application software 21A. Synchronization data display means 24 displays synchronization data. Data output means 2 is connected to PC 1 and accesses image data medium 3 that stores images and supplies the image data to PC 1.

### BACKGROUND OF THE INVENTION

The present invention relates to an image reproduction system and to a data synchronization method that is used in the system, and more particularly to an image-data synchronization system for reproducing an image.

In this type of image-data synchronization method, a method is conventionally adopted in which keywords relating to an image scene are first obtained from synchronism definition information (information that defines which image scene and which data are to be synchronized and displayed), and using the keywords, synchronous data (the data to be synchronized with the image scene of interest) are retrieved from a storage server on a network. The retrieved synchronous data are then synchronized to the image scene of interest. Accordingly, in order to synchronize data, synchronous data must first be retrieved through a retrieve system and then synchronized with the image.

In Japanese Patent Laid-open No. 353325/99, for example, a method is disclosed in which, in order to display synchronous data, keywords relating to an image scene to be viewed and heard are retrieved from synchronism definition information and data are retrieved and obtained from a storage server connected to the network.

FIG. 1 shows the configuration of this type of image reproduction system of the prior art. Referring now to FIG. 1, server 61 is provided with image data storage means 62, synchronism definition information storage means 63, image-related information storage means 64, synchronism definition information generation means 65, and communication control means 68.

Image data storage means 62 stores images that are to be viewed and transmits these images as necessary. Synchronism definition information storage means 63 stores synchronism definition information that defines the synchronization timing of an image and related information and transmits this information in response to requests.

Image-related information storage means 64 stores information relevant to images and transmits this information in accordance with requests. Synchronism definition information generation means 65 is called by terminal device 71 by way of a communication medium and newly generates synchronism definition information to dynamically generate relevant information of an image or the synchronous display contents of an image and relevant information.

Synchronism definition information generation means 65 is provided with synchronous content generation means 66 and image-related information generation means 67. Image-related information generation means 67 requests retrieval to information retrieval device 81 using communication control means 68, based on synchronism definition information in which related information is not defined, receives the results of the retrieval, define's this as the relevant information and dynamically generates new synchronism definition information, whereby the synchronous display content of the image and relevant information is generated.

Synchronous content generation means 66 dynamically generates new synchronism definition information based on synchronism definition information and image-related information that have been saved in synchronism definition information storage means 63, wherein the synchronism definition information and image-related information are generated based on information received from terminal device 71. In this way, the synchronous display content of an image and related information is generated.

Terminal device 71 includes communication control means 72, synchronization control means 73, output means 74, and information display means 75. Terminal device 71 communicates between communication control means 68 of server 61 and its own communication control means 72, obtains an image to be viewed from image data storage means 62, and acquires the image-related information from image-related information storage means 64.

Information retrieval device 81 accepts a retrieve request from server 61 or terminal device 71 by way of the communication medium, and returns the retrieval results to server 61 or terminal device 71 by way of the communication medium.

In the above-described image-data synchronization method of the prior art, connection to the Internet must be maintained while this synchronization system retrieves the synchronous content of the image based on synchronism definition information. Furthermore, retrieval time increases with increase in the amount of data to be retrieved, and thus a long wait is required until reproduction is realized. In cases in which retrieval does not operate correctly, moreover, there is a possibility of failure to detect data that are appropriate for synchronization.

It is an object of the present invention to solve the above-described problems and provide an image reproduction system and data synchronization method that enables easy establishment of synchronization of an image and synchronization data.

### SUMMARY OF THE INVENTION

A first image reproduction system includes a reproduction unit that reproduces image contents received from the outside and displays the image contents together with information relevant to the image contents.

The reproduction unit includes: an image reproduction counter that counts the time of reproduction of said image contents; and a means for synchronizing the relevant information with image contents in synchronization with a count value of the image reproduction counter corresponding to the synchronization timing designated by synchronism information. The synchronism information designates relevant information to be displayed and display timing.

The reproduction unit includes reproduction application software for reproducing and displaying the image contents and the relevant information. The image reproduction counter is provided in said reproduction application software.

As one embodiment of the present invention, the reproduction application software may include a script in which at least said synchronism information is written so that the reproduction application software will control the display of the relevant information in accordance with said synchronism information.

The reproduction unit may further includes: a synchronization data storage means for storing said relevant information; and a synchronization processing means for executing synchronous display of relevant information at a synchronization time specified by said synchronism information.

In this case, when executing a reproduction application program, the reproduction application software reads synchronism information from a script in advance; begins both counting of the image reproduction counter and display of image data when starting reproduction.

The reproduction application software reports a data name corresponding to the synchronization time to the synchronization processing means when the count value reaches a value that corresponds to a synchronization time designated by the synchronism information.

In this way, the synchronization processing means can execute a synchronization process of relevant information that corresponds to the reported data name.

Modification of the content of the relevant information or the synchronization time is realized by modifying said script.

As another embodiment of the first image reproduction system of the present invention, the reproduction unit may include: synchronization data acquisition means for acquiring the synchronism information and the relevant information by way of the Internet; synchronization data storage means for storing the relevant information; image acquisition means for acquiring image data; and synchronization processing means for executing synchronous display processing upon receiving the data name of relevant information to be displayed.

The reproduction application software receives synchronism information from said synchronization data acquisition means as well as image data, and, in addition to reproduction of the image data, begins count of said image reproduction counter simultaneously with the start of reproduction of the image data.

When the count value reaches a value that corresponds to a synchronization time designated by the synchronism information, reports the data name to be displayed at that synchronization time to the synchronization processing means.

The second image reproduction system of the present invention includes a reproduction unit that reproduces image contents received from the outside and displays the image contents together with information relevant to the image contents.

The reproduction unit includes: means for extracting a time stamp that indicates time information from the image content; and a means for synchronizing the relevant information with image contents in synchronization with the time stamp corresponding to the synchronization timing designated by synchronism information.

The reproduction unit includes reproduction application software for reproducing and displaying the image contents and the relevant information. The reproduction application software has a script in which at least the synchronism information is written.

In this way, the reproduction application software can control the display of the relevant information in accordance with the synchronism information.

The reproduction unit may further comprise:

synchronization data storage means for storing the relevant information; image acquisition means for acquiring image data; and synchronization processing means for effecting synchronous display processing of relevant information at a synchronization time designated by the synchronism information.

When executing a reproduction application program, the reproduction application software reads synchronism information from the script in advance, begins both the display of image data and the extraction of time stamps by controlling the time stamp acquisition means upon starting reproduction of the image data; and, when the time stamp value reaches a value that corresponds to a synchronization time designated by the synchronism information, reports a data name designated for the synchronization time to the synchronization processing means.

In this way, the synchronization processing means can execute synchronous display processing of the relevant information that corresponds to the reported data name.

In this embodiment of the second image reproduction system as well, modification of the content of the relevant information or said synchronization timing is conducted by modifying said script.

The reproduction unit may further comprise synchronization data acquisition means for acquiring the synchronism information and the relevant information by way of the Internet.

The first data synchronization method of the present invention is a data synchronization method of an image reproduction system including a reproduction unit that reproduces image contents received from the outside and displays the image contents together with information relevant to said image contents.

The data synchronization method includes steps of: counting the time of reproduction of the image contents; and displaying the relevant information synchronously with image contents in synchronization with a count value corresponding to the synchronization timing designated by synchronism information.

In an embodiment of the first data synchronization method, the method includes a step of executing reproduction of the image content by means of reproduction application software.

The reproduction application software performs steps of: before starting reproduction, reading a script in advance in which are written the name of the data to be reproduced and the time of synchronous reproduction of the data with corresponding image data; starting reproduction and displaying image data; counting the reproduction time; determining whether or not a synchronization time designated by the script has arrived; upon arrival of a synchronization time, reading relevant information for which the data name is written in the script from the medium that stores that relevant information and displaying the synchronization data.

Another embodiment of the first data synchronization method includes a step of executing reproduction of the image contents by reproduction application software.

When executing reproduction, the reproduction application software performs steps of: obtaining, from the Internet, relevant information for executing reproduction and display synchronously with image data and also obtaining synchronization times for synchronizing relevant information with image data, storing both the synchronization times and data names of synchronization data included in the relevant information as synchronism information, and storing the synchronization data in a synchronization data storage medium, in advance; starting reproduction and displaying image data; counting the reproduction time; determining whether or not a synchronization time designated by the synchronism information has arrived.

When a designated synchronization time arrives, steps of reading synchronization data having the data name designated corresponding to that synchronization time by the synchronism information, from the synchronization data storage medium; and executing the reproduction and display of the data; are performed.

The second data synchronization method of the present invention is a data synchronization method of an image reproduction system including a reproduction unit that reproduces image contents received from the outside and displays the image contents together with information relevant to the image contents.

The data synchronization method includes steps of: extracting a time stamp indicating time information from the image contents; and displaying the relevant information synchronously with image contents in synchronization with a time stamp corresponding to the synchronization timing designated by synchronism information.

In one embodiment of the data synchronization method, reproduction of the image content is executed by reproduction application software.

The reproduction application software performs steps of: before starting reproduction, reading a script in advance in which are written data names of relevant information to be executed and synchronization times at which display is to be carried out synchronously with corresponding image data; starting reproduction and acquiring image content data; extracting time stamps that are attached to the image data from the image content data; determining whether or not a time stamp matches a synchronization time designated by the script; and when matching occurs, reading relevant information indicated by the data name written in the script from the medium in which the relevant information are stored and processing the relevant information.

The image reproduction system and data synchronization method of the present invention are able to realize synchronous display of relevant data while reproducing, for example, a DVD (Digital versatile Disc), by taking advantage of an application software function that counts the reproduction time.

By means of the present invention, a viewer of the content of, for example, a DVD is not only able to view the reproduced image, but is also able to view or hear information that is relevant to the image or attached information in synchronization with the image.

In the present invention, the image reproduction application software may be executed on a personal computer.

In such a case, medium such as a DVD, video cassette, or a CD-ROM is inserted into a data output means such as a DVD drive, a D-VHS (Digital-VHS), or a CD-ROM drive, and image data are sent from the data output means to the personal computer.

The above and other objects, features, and advantages of the present invention will become apparent from the following description based on the accompanying drawings which illustrate examples of preferred embodiments of the present invention.

### BRIEF DESCRIPTION OF THE DRAWINGS

FIG. 1 is a block diagram showing the construction of a prior-art example of an image reproduction system.

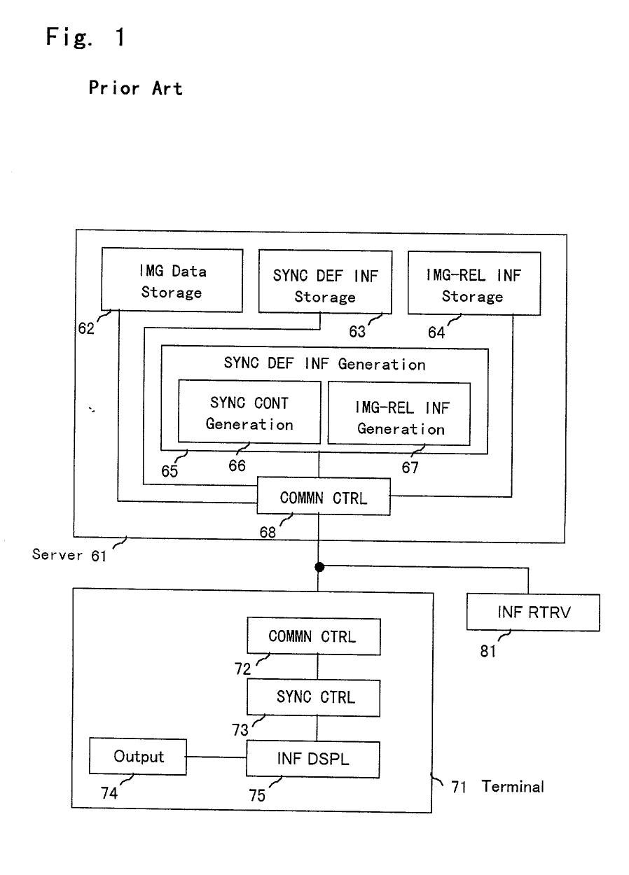

FIG. 2 is a block diagram showing the construction of the first embodiment of the first image reproduction system of the present invention.

FIG. 3 is a block diagram showing the construction of a PC of FIG. 2.

FIG. 4 shows an example of the script of FIG. 3.

FIG. 5 is a flow chart showing the processing operations of the image reproduction system of FIG. 2.

FIG. 6 is a block diagram showing the construction of the second embodiment of the first image reproduction system of the present invention.

FIG. 7 is a flow chart showing the processing operations of the image reproduction system of FIG. 6.

FIG. 8 is a block diagram showing the construction of an embodiment of the second image reproduction system of the present invention.

FIG. 9 is a flow chart showing the processing operations of the image reproduction system of FIG. 8.

### DETAILED DESCRIPTION OF THE PREFERRED EMBODIMENTS

Referring now to the accompanying drawings, embodiments of the present invention are next described.

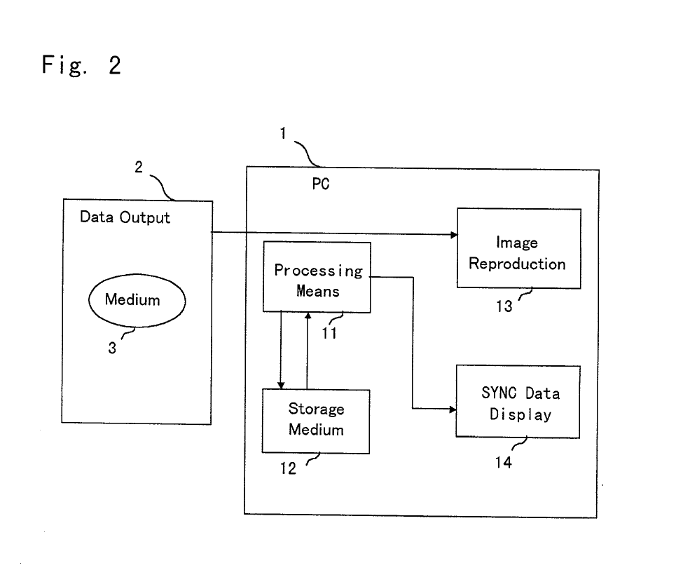

Referring to FIG. 2, there is shown the construction of the first embodiment of the first image reproduction system of the present invention. In FIG. 2, the image reproduction system of this embodiment is constituted by PC (personal computer) 1, data output device 2, and medium 3.

PC 1 includes synchronization processing means 11, storage medium 12, image reproduction means 13, and synchronization data display means 14; and executes reproduction application software for reproducing an image.

Synchronization processing means 11 effects processing to display image data that are received from data output device 2. Storage medium 12 is managed by synchronization processing means 11 and stores synchronization data. Image reproduction means 13 displays image data that have been processed by synchronization processing means 11. Synchronization data display means 14 processes synchronization data and displays the processed data. Synchronization data are data that are relevant to an image and also that are to be displayed in synchronization with the image.

Medium 3 stores image data. In this embodiment, medium 3 is a recording medium such as a DVD, a video cassette, or a CD-ROM. Data output device 2 is a device that captures data from medium 3, and in this embodiment is, for example, a DVD drive, a D-VHS, or a CD-ROM drive. Data output device 2 is connected to PC 1 and sends image data that have been captured from medium 3 to PC 1.

The reproduction application software includes a counter function that indicates the image display time, and further includes the function of reading in advance a script of synchronization timings. In accordance with the script that has been read in advance, the reproduction application software notifies the arrival of a synchronization time to synchronization processing means 11 when a synchronization timing arrives.

Upon being notified of a synchronization timing by the reproduction application software, synchronization processing means 11 reads from storage medium 12 the synchronization data to be displayed at the synchronization timing, and sends these synchronization data to synchronization data display means 14. Upon receiving the synchronization data, synchronization data display means 14 immediately carries out processing for the display of the synchronization data, whereby the synchronization of the image and relevant synchronization data is realized.

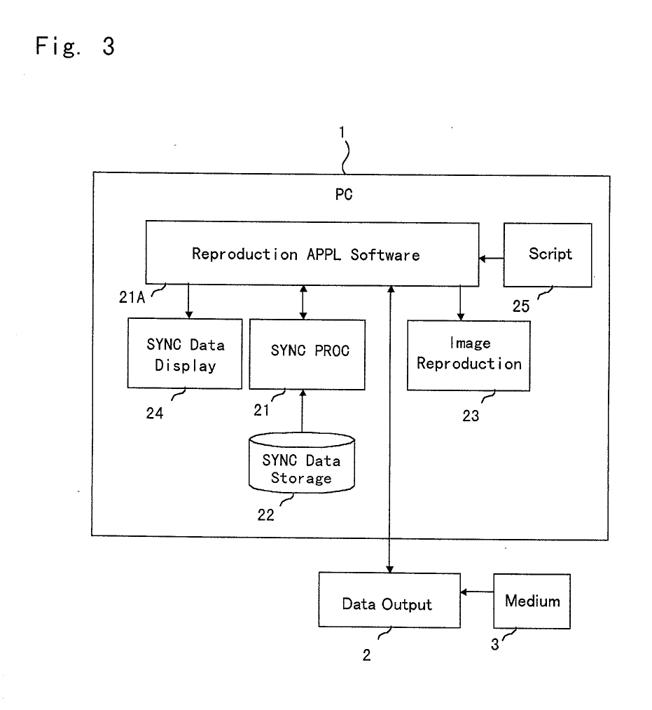

FIG. 3 is a block diagram showing the construction of a first embodiment of the present invention. In FIG. 3, the image reproduction system of this embodiment is provided with PC 1, data output device 2, and medium 3.

PC 1 is provided with reproduction application software 21A, synchronization processing means 21, script 25, synchronization data storage means 22, image reproduction means 23, and synchronization data display means 24.

Reproduction application software 21A processes image data that are received from data output device 2 and executes control for display.

Synchronization processing means 21 carries out the process of synchronizing image data with the synchronization data to be displayed in relation to and in synchronization with the image data. The timing of synchronization and the data name of the synchronization data for which synchronization processing is to be executed are written in script 25. Synchronization data storage medium 22 stores the synchronization data. Image reproduction means 23 displays image data that have been processed by reproduction application software 21A.

Synchronization data display means 24 realizes the display of synchronization data for which synchronization processing has been carried out.

Data output device 2 is a device such as a DVD drive, a D-VHS, or a CD-ROM drive. Data output device 2 is connected to PC 1 and captures image data from medium 3 (in this case, a recording medium such as a DVD, a video cassette, or a CD-ROM) that stores images, and supplies the captured data to PC 1.

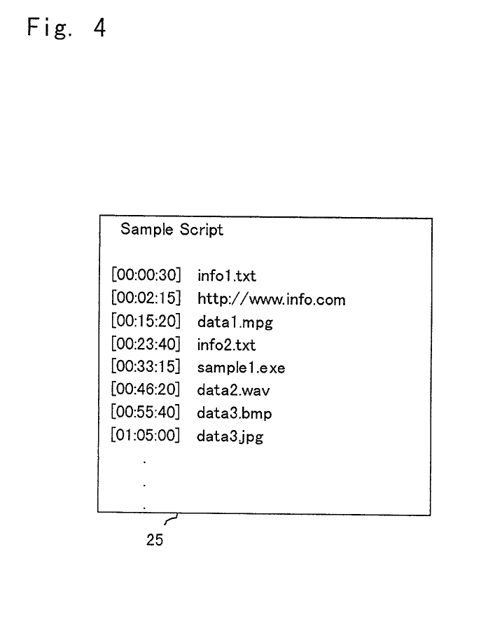

FIG. 4 shows an example of script 25 of FIG. 3. In FIG. 4, the following data are written in script 25:

[00:00:30] info1.txt

[00:02:15] http://www.info.com

[00:15:20] data1.mpg

[00:23:40] info2.txt

[00:33:15] sample1.exe

[00:46:20] data2.wav

[00:55:40] data3.bmp

[01:05:00] data3.jpg

The extensions, txt, mpg, exe, bmp, and jpg are known extensions indicating a text file, a moving picture file, an application file, a still image file, and a still image file, respectively.

In addition, “http://www. - - - ” is the URL (Uniform Resource Locator) of a site on the World Wide Web. This is the URL of a site on the World Wide Web that provides information when synchronism information is to be obtained from the Internet. The numerals indicate the synchronization times. Modification of the content of synchronization data or synchronization time is realized by modifying the script.

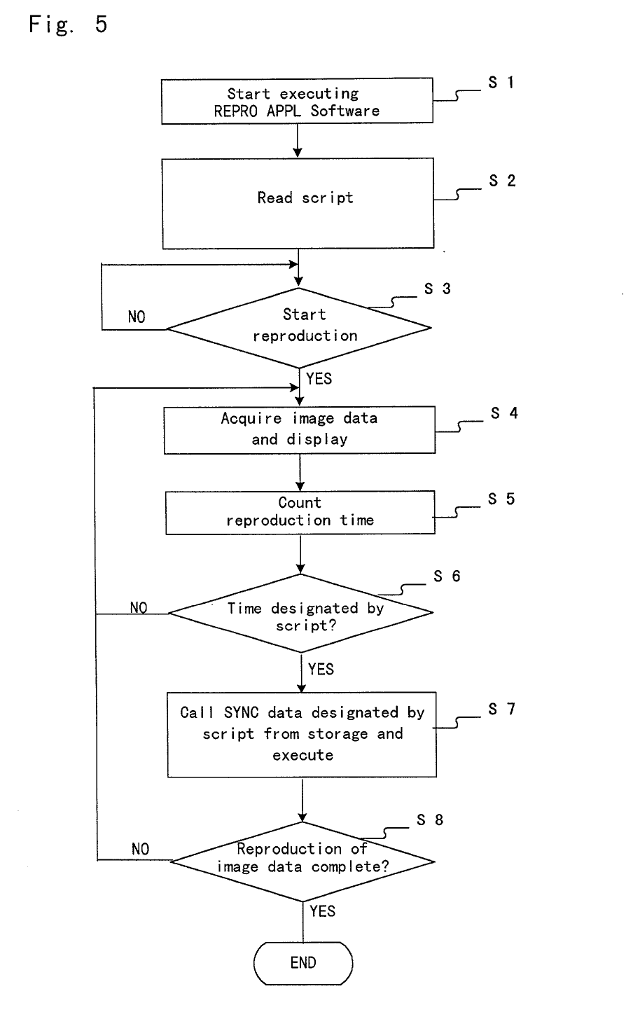

FIG. 5 is a flow chart showing the processing operations of the image reproduction system of this embodiment. The processing operations of the image reproduction system of this embodiment are next described referring to FIGS. 3-5.

Upon starting the reproduction of an image (Step S1) reproduction application software 21A first reads an item of script 25 that corresponds to medium 3 inserted in data output device 2 (Step S2 in FIG. 5). The time that synchronous display is to be carried out and the names of synchronization data for which synchronous display is to be carried out are written in script 25.

Next, when the playback button is pressed in reproduction application software 21A and the reproduction of image data starts (Step S3 in FIG. 5), image data are transmitted from data output device 2 to PC 1, image data are sent from reproduction application software 21A to image reproduction means 23, and image display is effected by image reproduction means 23 (Step S4 in FIG. 5).

When image reproduction is started, reproduction application software 21A counts the reproduction time (Step S5). Reproduction application software 21A uses an ordinary clock as the counter. Reproduction application software 21A keeps a count with the counter. In the present embodiment, the synchronization timing between the image data and synchronization data is established with reference to the count value of the counter. Upon arrival of a time designated by script 25 that has been read in advance (Step S6), the synchronous display of synchronization data designated by script 25 is executed (Step S7). The processes of the above-described Steps S4-S7 are repeated until the image reproduction process is completed (Step S8).

Synchronization processing means 21 invokes the synchronization data necessary for executing the operation of data designated by script 25 (for example, playing the designated music when the data designates music) from synchronization data storage means 22 (for example, a hard disk) and sends it to synchronization data display means 24 by way of reproduction application software 21A.

Or, synchronization processing means 21 can send the invoked synchronization data directly to synchronization data display means 24 under the control of reproduction application software 21A.

Synchronization data display means 24 carries out processing to display the received synchronization data.

The synchronization data can be moving picture data, still image data, voice/music data, text data, or URL. To display or reproduce these data, the application software (In FIG. 4, a file indicated by the extension “exe”) that is associated through the OS (Operating System) may be invoked and executed.

Executing the above-described function brings about synchronization between the reproduced image and the execution of the synchronization data, whereby synchronization of the image and synchronization data is easily performed.

In this way, using the image reproduction counter of reproduction application software 21A enables easy establishment of synchronization of an image and synchronization data without embedding the synchronization data or information into the image.

In addition, eliminating the need to incorporate synchronism information into the image can facilitate preparation of synchronism information for image data, and further, enables promotion of image data sales or facilitates the offering of a service to add data to image data.

Furthermore, since synchronism information and synchronous data can be provided independently of the image medium and a user can obtain and store synchronism information and synchronous data by any method including a floppy disk, CD-ROM, or a download from the Internet, the handling of synchronism information and synchronous data is simplified.

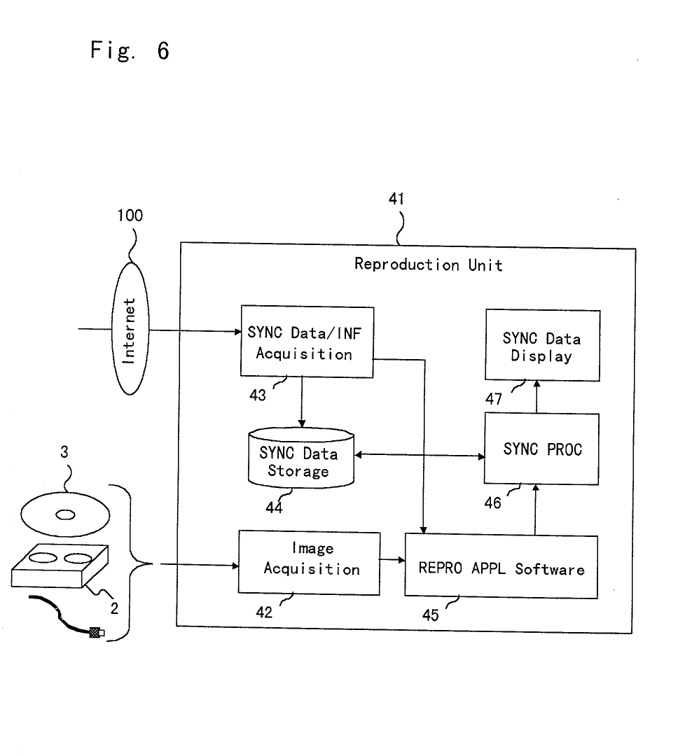

FIG. 6 is a block diagram showing the configuration of the second embodiment of the image reproduction system of the present invention. Referring now to FIG. 6, the image reproduction system of this embodiment is provided with reproduction unit 41, data output device 2, and medium 3.

Data output device 2 is constituted by, for example, a DVD drive, a D-VHS, or a CD-ROM drive, reads image data from medium 3 in which images are stored (in this case, a recording medium such as a DVD, a video cassette, or a CD-ROM) and supplies the image data to reproduction unit 41.

Reproduction unit 41 is provided with image acquisition means 42, synchronization data/information acquisition means 43, synchronization data storage means 44, reproduction application software 45, synchronization processing means 46, and synchronization data display means 47.

Image acquisition means 42 is connected to data output device 2, and synchronization data/information acquisition means 43 is connected to Internet 100. Reproduction unit 41 can be a set-top box, a TV, or a PC.

Synchronization data/information acquisition means 43 acquires, by way of Internet 100, the synchronism information and synchronization data corresponding to the image content to be viewed. Synchronization data storage means 44 stores the synchronization data of the information that has been acquired by synchronization data/information acquisition means 43. Image acquisition means 42 acquires the image from the medium of data output device 2.

Reproduction application software 45 receives the synchronism information included in the information acquired by synchronization data/information acquisition means 43 as well as the image to be viewed supplied from image acquisition means 42, and controls an image reproduction means (not shown in the figures) to reproduce the image. Reproduction application software 45 also notifies the data name that is to be synchronized to synchronization processing means 46 when a time arrives that is designated in the synchronism information.

Upon receiving notification from reproduction application software 45, synchronization processing means 46 accesses synchronization data storage means 44 for synchronization data and delivers the data to synchronization data display means 47. Upon receiving the synchronization data, synchronization data display means 47 carries out display processing of the data.

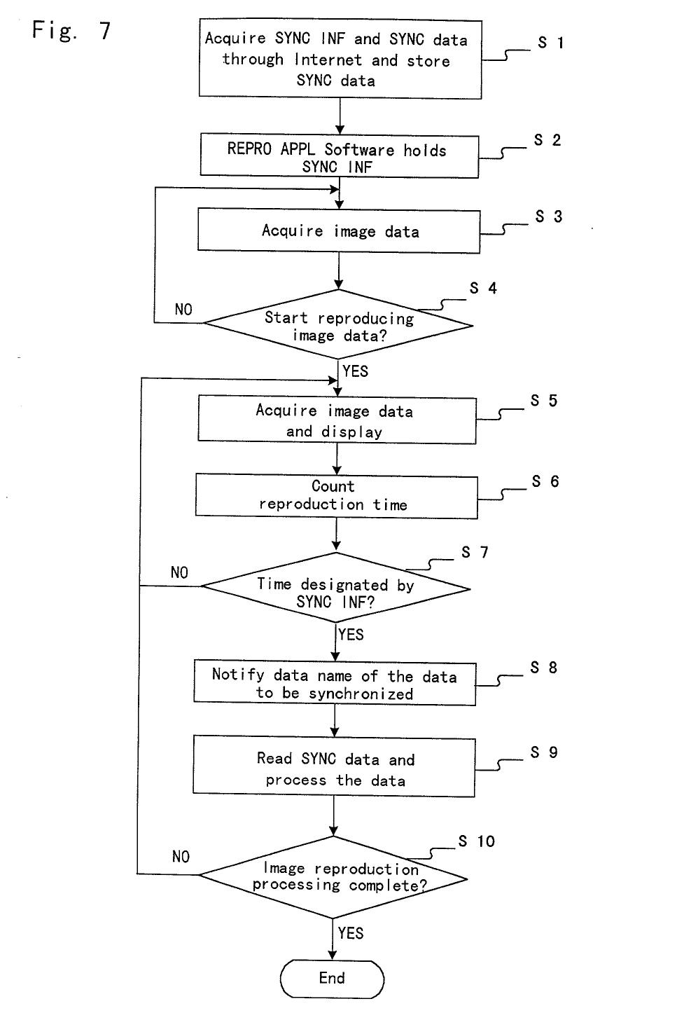

FIG. 7 is a flow chart showing the processing operations of the image reproduction system according to the second embodiment. Referring to FIGS. 6 and 7, the processing operations of the image reproduction system of this embodiment are next described.

When image content is to be viewed, reproduction unit 41 obtains in advance the synchronism information and synchronization data that correspond to the image content of interest by means of synchronization data/information acquisition means 43 by way of the Internet (Step S1). The synchronization data are stored in synchronization data storage means 44.

The synchronization time and the data name to be synchronized at that time are described in the synchronism information. The synchronism information is transmitted to reproduction application software 45, and reproduction application software 45 reads the synchronism information in advance (Step S2).

When the transfer of the synchronism information and the storage of the synchronization data have been completed, image acquisition means 42 begins the acquisition of the image from a DVD, video cassette, satellite, or cable (Step S3).

When reproduction application software 45 begins the reproduction of the image (Steps S4 and S5), a counter of the reproduction time (not shown in the figure) increments a time count (Step S6).

Upon arrival of a time designated in the synchronism information having been read in advance (Step S7), reproduction application software 45 notifies the data name of the synchronization data to be synchronized to synchronization processing means 46.

Upon receiving notification, synchronization processing means 46 reads synchronization data from synchronization data storage means 44 and delivers the synchronization data to synchronization data display means 47. Upon receiving the synchronization data, synchronization data display means 47 carries out display processing of the data (Step S9). The synchronization data are assumed to be a still image, a moving picture, speech, or the designation of a URL.

Synchronization of an image and synchronization data is realized by the above-described operations. The processing of the above-described Steps S5-S9 is repeated until the image reproduction process is completed (Step S10).

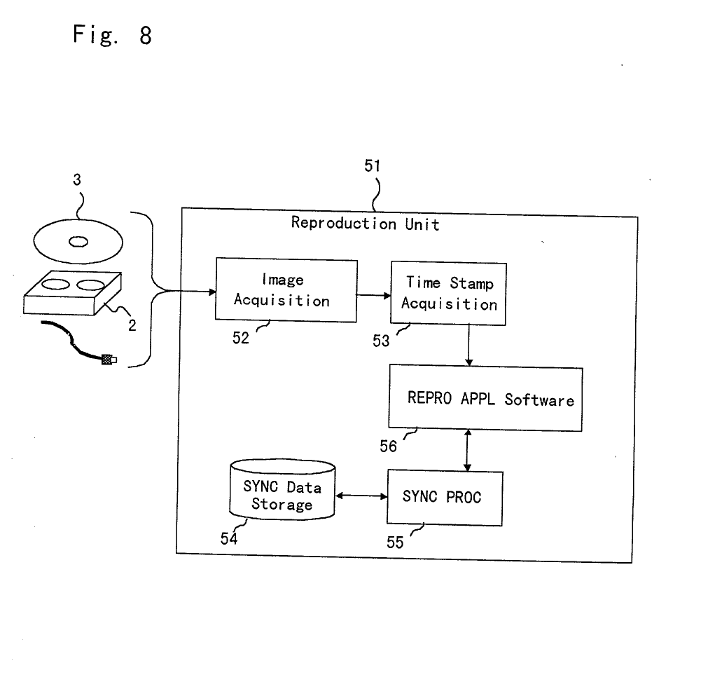

FIG. 8 is a block diagram showing the configuration of an embodiment of a second image reproduction system of the present invention. The image reproduction system of this embodiment is provided with reproduction unit 51, data output device 2, and medium 3.

Reproduction unit 51 is provided with image acquisition means 52, time stamp acquisition means 53, synchronization data storage means 54, synchronization processing means 55, and reproduction application software 56. Reproduction unit 51 is a device such as a set-top box, a TV, or a PC.

Data output device 2 is constituted by a DVD drive, a D-VHS, or a CD-ROM drive, and reads image data from medium 3 (in this case, a recording medium such as a DVD, video cassette, or CD-ROM) that stores images, and supplies to reproduction unit 51.

Image acquisition means 52 acquires image content data from medium 3. Time stamp acquisition means 53 extracts, from the received image content data, time stamps for indicating time information and delivers this information and the image content data to reproduction application software 56.

Synchronization data storage means 54 stores synchronization data that have been obtained by any method.

Reproduction application software 56 takes the time stamps received from time stamp acquisition means 53 as a synchronization time reference. Reproduction application software 56 notifies synchronization processing means 55 of the arrival of a synchronization time when the time comes. The synchronization time is described in the script that was read in advance. Upon receiving this notification, synchronization processing means 55 reads the synchronization data to be synchronized from synchronization data storage means 54 and processes the data.

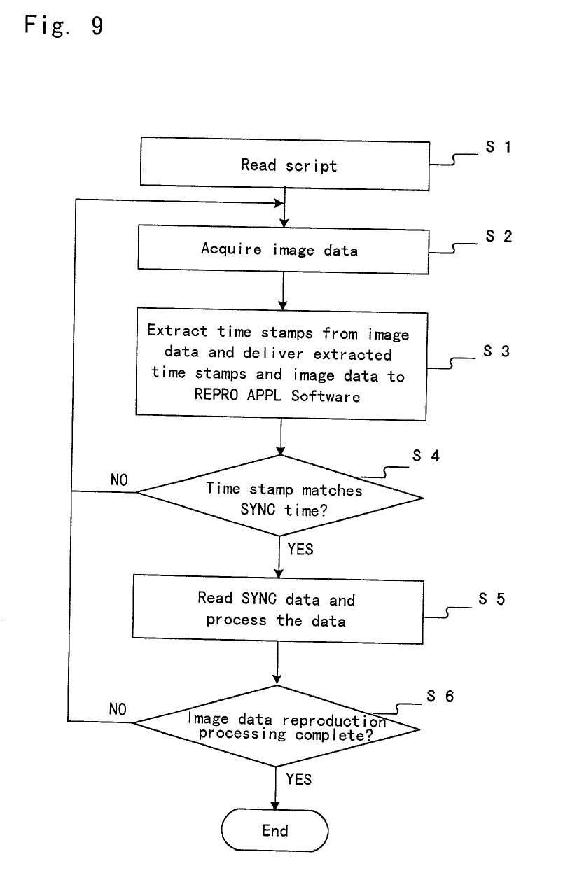

FIG. 9 is a flow chart showing the processing operations of the image reproduction system of the present embodiment. Explanation next regards the processing operations of the image reproduction system of this embodiment with reference to FIGS. 8 and 9.

Reproduction application software 56 reads in advance a script (Step S1). Reproduction unit 51 acquires image content data through image acquisition means 52 (Step S2). Image acquisition means 52 transmits the acquired image content data to time stamp acquisition means 53. Time stamp acquisition means 53 extracts, from the received image content data, the time stamps that indicate time information and delivers this information as well as the image content data to reproduction application software 56 (Step S3).

Reproduction application software 56 takes the time stamps received at any time as a synchronization time reference, and decides arrival of a synchronization time that is described in the script (Steps S4). Reproduction application software 56 notifies the arrival of the synchronization time of interest to synchronization processing means 55.

Upon receiving notification, synchronization processing means 55 reads the synchronization data for which synchronous display is to be effected, from synchronization data storage means 54 and processes the data (Step S5). Synchronization of image contents and synchronization data is thus achieved.

The processing of the above-described Steps S2-S5 is executed repeatedly until the image reproduction process has been completed (Step S6).

As described in the foregoing explanation, a preciser synchronization can be realized by taking advantage of the time stamps.

According to the present invention as described in the foregoing explanation, the establishment of synchronization of image data and synchronization data can be easily achieved in an image reproduction system by referring to a count value of an image reproduction counter that counts the reproduction-display time of the image content or to a time stamp associated with the image content that is being reproduced, based on synchronism information that have been read in advance.

While preferred embodiments of the present invention have been described using specific terms, such description is for illustrative purposes only, and it is to be understood that changes and variations may be made without departing from the spirit or scope of the following claims.

What is claimed is:

1. An image reproduction system including a reproduction unit that reproduces image contents received from the outside and displays the image contents together with information relevant to the image contents, said reproduction unit including:
an image reproduction counter that counts the time of reproduction of said image contents, and
a means for synchronizing the relevant information with image contents in synchronization with a count value of said image reproduction counter corresponding to the synchronization timing designated by synchronism information,
said synchronism information designating relevant information to be displayed and display timing.

2. An image reproduction system according to claim 1, wherein said reproduction unit includes reproduction application software for reproducing and displaying said image contents and said relevant information, said image reproduction counter being provided in said reproduction application software.

3. A image reproduction system according to claim 2, wherein said reproduction application software includes a script in which at least said synchronism information is written so that said reproduction application software will control the display of said relevant information in accordance with said synchronism information.

4. An image reproduction system according to claim 3, said reproduction unit further including:
a synchronization data storage means for storing said relevant information, and
a synchronization processing means for executing synchronous display of relevant information at a synchronization time specified by said synchronism information;
wherein, when executing a reproduction application program, said reproduction application software reads synchronism information from a script in advance; begins both counting of said image reproduction counter and display of image data when starting reproduction of said image contents; and reports a data name corresponding to said synchronization time to said synchronization processing means when the count value reaches a value that corresponds to a synchronization time designated by said synchronism information; so that said synchronization processing means will execute a synchronization process of relevant information that corresponds to the reported data name.

5. An image reproduction system according to claim 3, wherein modification of the content of said relevant information or said synchronization time is realized by modifying said script.

6. An image reproduction system according to claim 2, wherein said reproduction unit including:
synchronization data acquisition means for acquiring said synchronism information and said-relevant information by way of the Internet;
synchronization data storage means for storing said relevant information;
image acquisition means for acquiring image data; and
synchronization processing means for executing synchronous display processing upon receiving the data name of relevant information to be displayed;
wherein said reproduction application software receives synchronism information from said synchronization data acquisition means as well as image data, and, in addition to reproduction of the image data, begins count of said image reproduction counter simultaneously with the start of reproduction of the image data, and when the count value reaches a value that corresponds to a synchronization time designated by said synchronism information, reports the data name to be displayed at that synchronization time to said synchronization processing means.

7. An image reproduction system including a reproduction unit that reproduces image contents received from the outside and displays the image contents together with information relevant to the image contents, said reproduction unit including:
means for extracting a time stamp that indicates time information from said image content; and
a means for synchronizing the relevant information with image contents in synchronization with said time stamp corresponding to the synchronization timing designated by synchronism information,
said synchronism information designating relevant information to be displayed and display timing.

8. An image reproduction system according to claim 7, wherein said reproduction unit includes reproduction application software for reproducing and displaying said image contents and said relevant information, said reproduction application software including a script in which at least said synchronism information is written so that said reproduction application software will control the display of said relevant information in accordance with said synchronism information.

9. An image reproduction system according to claim 8, said reproduction unit further comprising:
synchronization data storage means for storing said relevant information,
image acquisition means for acquiring image data; and
synchronization processing means for effecting synchronous display processing of relevant information at a synchronization time designated by said synchronism information;
wherein, when executing a reproduction application program, said reproduction application software reads synchronism information from said script in advance, begins both the display of image data and the extraction of time stamps by controlling said time stamp acquisition means upon starting reproduction; and, when the time stamp value reaches a value that corresponds to a synchronization time designated by the synchronism information, reports a data name designated for the synchronization time to said synchronization processing means, so that said synchronization processing means will execute synchronous display processing of the relevant information that corresponds to the reported data name.

10. An image reproduction system according to claim 8, wherein modification of the content of said relevant information or said synchronization timing is conducted by modifying said script.

11. An image reproduction system according to claim 9, said reproduction unit further comprising synchronization data acquisition means for acquiring said synchronism information and said relevant information by way of the Internet.

12. A data synchronization method of an image reproduction system including a reproduction unit that reproduces image contents received from the outside and displays the image contents together with information relevant to said image contents, said data synchronization method including steps of:
counting the time of reproduction of said image contents, and
displaying the relevant information synchronously with image contents in synchronization with a count value corresponding to the synchronization timing designated by synchronism information,
said synchronism information designating relevant information to be displayed and display timing.

13. A method according to claim 12, including a step of executing reproduction of said image contents by reproduction application software, and said reproduction application software performing steps of:
before starting reproduction, reading a script in advance in which are written the name of the data to be reproduced and the time of reproduction of said data synchronous with corresponding image data;
starting reproduction and displaying image data;
counting the reproduction time;
determining whether or not a synchronization time designated by said script has arrived;
upon arrival of a synchronization time, reading relevant information for which the data name is written in said script from the medium that stores that relevant information, and displaying the synchronization data.

14. A data synchronization method according to claim 13, including a step of modifying the contents of said relevant information or said synchronization timing by modifying said script.

15. A method according to claim 12, including a step of executing reproduction of said image contents by reproduction application software, and when executing reproduction, said reproduction application software performing steps of:
obtaining, from the Internet, relevant information for executing reproduction and display synchronously with image data and also obtaining synchronization times for synchronizing relevant information with image data, storing both the synchronization times and data names of synchronization data included in the relevant information as synchronism information and storing the synchronization data in a synchronization data storage medium, in advance;
starting reproduction and displaying image data;
counting the reproduction time;
determining whether or not a synchronization time designated by said synchronism information has arrived;
when a designated synchronization time arrives, reading synchronization data having the data name designated corresponding to that synchronization time by said synchronism information, from said synchronization data storage medium; and
executing the reproduction and display of the data.

16. A data synchronization method of an image reproduction system including a reproduction unit that reproduces image contents received from the outside and displays the image contents together with information relevant to said image contents, said data synchronization method including steps of:
extracting a time stamp indicating time information from said image contents; and
displaying the relevant information synchronously with image contents in synchronization with a time stamp corresponding to the synchronization timing designated by synchronism information,
said synchronism information designating relevant information to be displayed and display timing.

17. A method according to claim 16, wherein reproduction of said image content is executed by reproduction application software, said reproduction application software performing steps of:
before starting reproduction, reading a script in advance in which are written data names of relevant information to be executed and synchronization times at which display is to be carried out synchronously with corresponding image data;
starting reproduction and acquiring image content data;
extracting time stamps that are attached to the image data from the image data;
determining whether or not a time stamp matches a synchronization time designated by the script; and
when matching occurs, reading relevant information indicated by the data name written in the script from the medium in which the relevant information are stored, and processing the relevant information.

18. A data synchronization method according to claim 17, including a step of modifying said script to modify the content of said relevant information or said synchronization time.

19. A data synchronization method according to claim 16, including a step of acquiring said synchronization times and said relevant information by way of the Internet.
